(19) United States
(12) Patent Application Publication
(10) Pub. No.: US 2015/0084805 A1
(43) Pub. Date: Mar. 26, 2015

(54) Detection Techniques

(71) Applicant: QINETIQ LIMITED, Hampshire (GB)

(72) Inventor: William Nicholas Dawber, West Ashling (GB)

(21) Appl. No.: 14/384,333

(22) PCT Filed: Mar. 14, 2013
(86) PCT No.: PCT/GB2013/000111

§ 371 Date: Sep. 10, 2014

(30) Foreign Application Priority Data
Mar. 19, 2012 (GB) 1204792.4

(51) Int. Cl. G01S 13/28; G01S 13/58

(52) U.S. Cl. CPC G01S 13/28; G01S 13/581
USPC 342/28

(57) ABSTRACT

Some embodiments are directed to techniques that mitigate the problems of range walk where fast moving objects are detected using pulsed target detection systems having relatively long dwell times. A pulse generator for a pulsed target detection system controls generation of a series of pulses to be transmitted by the target detection system. The time between pulses and pulse characteristics are controlled such that any range migration due to target movement in the time between pulses of said series is substantially equal and opposite to any variation in range-Doppler coupling between the pulses due to said target movement. By controlling the transmitted pulses in this way, any potential variation in range cell due to target motion is offset by an equal and opposite variation in range-Doppler coupling, whatever the target radial velocity. The techniques are particularly applicable to radar systems.

This invention relates to methods and apparatus for detection of objects and, in particular to methods and apparatus for pulse-compression radar that mitigate for problems of range-walk between pulses.

In radar applications involving the detection of relatively faint targets, such as targets at long range, for example objects in orbit or at very high altitude, the signal returns from any given transmitted pulse may be relatively low. Whilst signal returns may be improved by increasing the power of the transmitted pulse there may be limits on the peak instantaneous power it is practical or desirable to transmit. Signal returns can also be improved by transmitting longer pulses but at the expense of reduced range resolution.

Many radar systems used for such applications therefore use pulse compression techniques in which individual pulses may be transmitted with a time varying frequency or phase. The detected returns can then be processed using known pulse compression techniques so as to, in effect, combine the various frequency components to replicate a single pulse with a higher peak power and shorter duration than the pulse actually transmitted. Typically a linear frequency chirp is applied to the pulse, i.e. the variation in frequency is linear with time, but other frequency modulations are also known.

In addition conventional radar systems typically operate by transmitting a series of pulses within the dwell time of a single look direction and integrate the returns from the various pulses to improve signal-to-noise ratio (SNR) as compared to using a single pulse. The integration may comprise coherent integration and/or incoherent integration.

Incoherent integration integrates the detected signal power in each range cell from the various single pulses. This can improve SNR by a factor of up to √N, where N is the number of pulse returns combined. Coherent integration combines the phase and amplitude of the detected returns and can offer SNR improvements of up to N times that for a single pulse.

Coherent integration does however require that each pulse has the same frequency characteristic. In some radar applications it is desirable to vary the nominal frequency of the pulses transmitted within each dwell time, e.g. to vary the centre frequency (or other characteristic frequency) of a chirped pulse. The signal return from an object may be frequency dependent and some frequencies may happen to give poor returns. In addition there may be intentional or unintentional interference on certain frequencies. Thus, especially when trying to detect objects at long range and/or fast moving objects, it can be beneficial to use a plurality of different transmitted frequencies so as to improve probability of detection.

Some known radar systems may therefore transmit a plurality of bursts of pulses within a dwell time. Within each burst there may be several pulses having the same nominal frequency, with the nominal frequency being varied from burst to burst. The returns from pulses within a burst may be coherently integrated, with the combined returns for each burst being incoherently integrated.

When applied to fast moving targets, for example detection of satellites in orbit or the like, a problem can occur that the target may move a considerable distance during the dwell time. This is especially the case where a long dwell time is required to allow detection of targets at long range. Thus the target may move between several range cells within the dwell time. Thus the integration of the signal returns in any given range cell will only involve some of the returns from the target.

In addition, as the skilled person will appreciate, the radar returns from a moving target will exhibit a Doppler shift related to the radial velocity of the target. The amount of Doppler shift depends however on the frequency of the transmitted radiation. As mentioned above to increase detection probability pulses may be transmitted with frequency characteristics that vary from burst to burst. This will lead to varying amounts of Doppler shift. The range-Doppler coupling inherent in the pulse compression processing may therefore result in the returns from one burst being coupled to a different range cell to the returns from another burst.

These effects therefore result in the energy from the target being effectively spread between several different range cells, thus reducing the SNR gain of integration and potentially falsely indicating several distinct targets. As a result some targets may be missed.

One proposed approach to dealing with this problem is to estimate a range of possible target motions and to perform a separate combination for each hypothesis taking the estimated motion into account. The results of all of the combinations can then be analysed to detect any significant energy in a single range cell. Such track-before-detect type approaches can be extremely computationally intensive however and add significant complexity to a radar system used for real time detection.

Embodiments of the present invention therefore relate to methods and apparatus for target detection that at least mitigate some of the above mentioned disadvantages.

Thus according to the present invention there is provided a pulse controller for a pulsed target detection system, the pulse controller being configured to, in use, control generation of a series of pulses to be transmitted by the pulsed target detection system, wherein the time between pulses and pulse characteristics are controlled such that any range migration due to target movement in the time between pulses of said series is substantially equal and opposite to any variation in range-Doppler coupling between the pulses due to said target movement.

As will be described in more detail later by control of the series of pulses transmitted by a pulsed target detection system, such as a radar system, in any given look direction, the effect of range-Doppler coupling can be effectively tuned to be substantially equal and opposite to any range migration, whatever the target radial velocity. Thus any potential variation in detected range cell due to target motion is offset by the variation in range-Doppler, meaning that spreading of target returns between several range cells can be reduced or eliminated.

The technique is particularly applicable to radar systems and the pulse controller may control the generation of a series of pulses of electromagnetic radiation to be transmitted by a radar system. However other types of pulse target detection systems may also benefit from the same techniques, for example sonar or lidar systems.

Each pulse may have a time-varying frequency modulation, e.g. to allow pulse compression. The pulse characteristics controlled by the pulse controller may comprise at least one of nominal pulse frequency, pulse duration and applied frequency modulation. The time-varying frequency modulation may comprise a substantially linear frequency chirp.

In one arrangement, when applying a linear frequency chirp to the transmitted pulses, the pulse controller may be configured to generate pulses that substantially satisfy the equation:

$${t}_{p} - {t}_{p - 1} = \frac{{τ}_{p} {F}_{p}}{{B}_{p}} - \frac{{τ}_{p - 1} {F}_{p - 1}}{{B}_{p - 1}}$$

wherein t is the time of pulse transmission, τ is the pulse duration, F is the nominal pulse frequency and B is the bandwidth of the frequency chirp and the subscript p-1 denotes a first pulse and the subscript p denotes a later pulse in the series.

The pulse controller may be configured to, in use, generate a plurality of pulses at a constant pulse repetition interval. The controller may be configured to, in use, vary the nominal frequency of at least some pulses in the series and/or generate at least some pulses having the same nominal frequency. The pulse repetition interval, pulse duration and/or modulation bandwidth may additionally or alternatively be varied.

The invention also provides a radar system comprising a pulse controller as described above. The radar system may comprise a detector configured to produce pulse compressed signal returns from each of said pulses and integrate at least some of the pulse compressed signal returns. As will be understood be one skilled in the art the detector may apply a matched filter which is matched to a pulse waveform transmitted.

The invention also relates to a method of target detection. Thus in another aspect of the invention there is provided a method of target detection comprising transmitting a series of pulses in a given look direction wherein the time between pulses and pulse characteristics are configured such that any range migration due to target movement in the time between pulses of said series is substantially equal and opposite to any variation in range-Doppler coupling between the pulses due to said target movement.

The method can operate in all of variants as described in relation to the first aspect of the invention. In particular each pulse may have a time-varying frequency modulation, which may comprise a substantially linear frequency chirp.

The time between pulses and pulse characteristics may be controlled so as to substantially satisfy the equation:

$${t}_{p} - {t}_{p - 1} = \frac{{τ}_{p} {F}_{p}}{{B}_{p}} - \frac{{τ}_{p - 1} {F}_{p - 1}}{{B}_{p - 1}}$$

wherein t is the time of pulse transmission, τ is the pulse duration, F is the nominal pulse frequency and B is the bandwidth of the frequency chirp and the subscript p-1 denotes a first pulse and the subscript p denotes a later pulse in the series.

The invention may be implemented as a computer program and thus the invention also provides a computer program comprising computer readable code for instructing a suitable computing device to perform the method described above. The invention also relates to a computer program comprising computer readable code which, when executed on a suitable computing device, enables a pulse controller as described above.

The invention will now be described by way of example only, with reference to the accompanying drawings, of which:

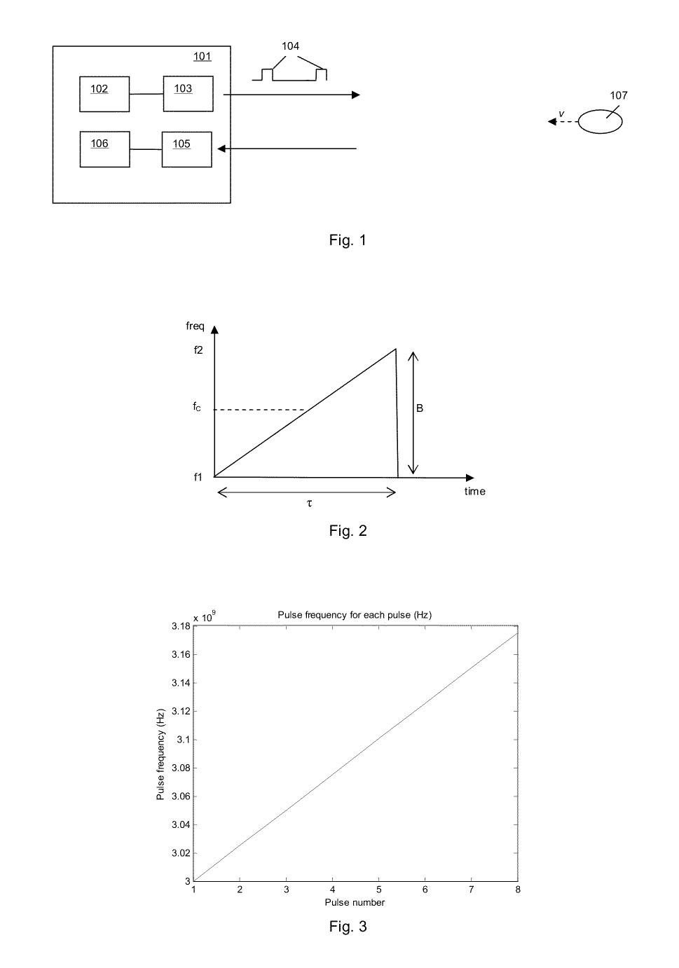

FIG. 1 illustrates a pulse compression radar system according to an embodiment of the present invention;

FIG. 2 illustrates a linear up chirp;

FIG. 3 illustrates how frequency may be varied from pulse to pulse in accordance with an embodiment of the invention;

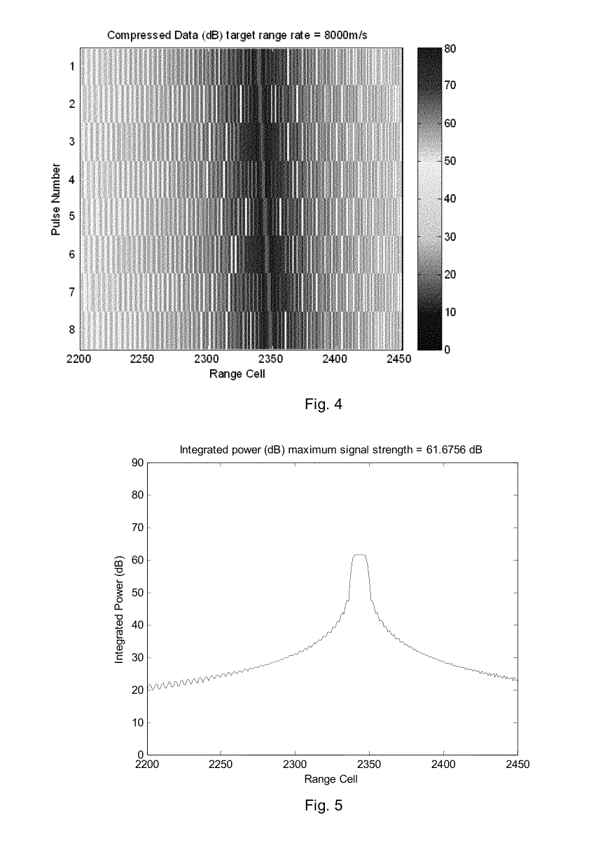

FIG. 4 illustrates the modelled power in each range cell of a conventional pulse compressed radar system with an eight pulse burst;

FIG. 5 illustrates the incoherently integrated power of the signal returns shown in FIG. 4;

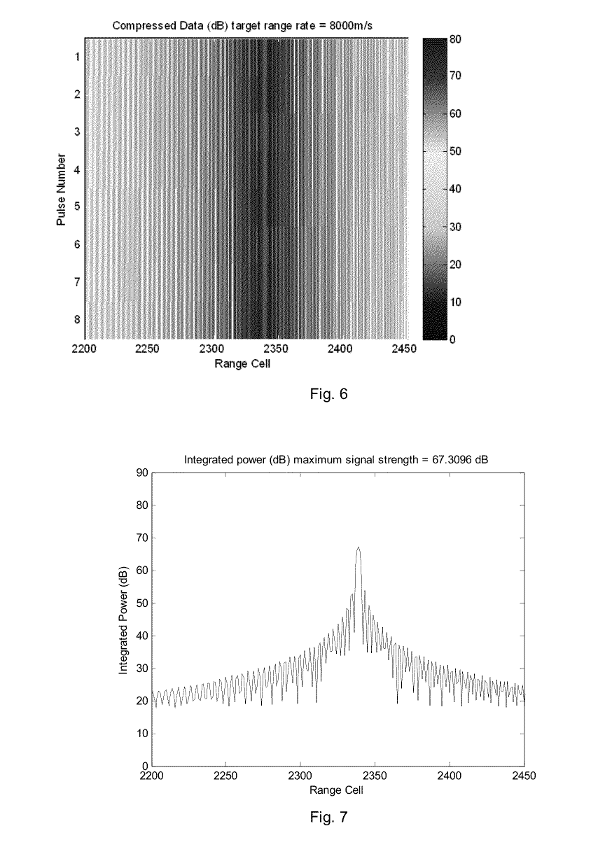

FIG. 6 illustrates the modelled power in each range cell of a pulse compressed radar system with a pulse-to-pulse frequency variation as shown in FIG. 3;

FIG. 7 illustrates the incoherently integrated power of the signal returns shown in FIG. 6;

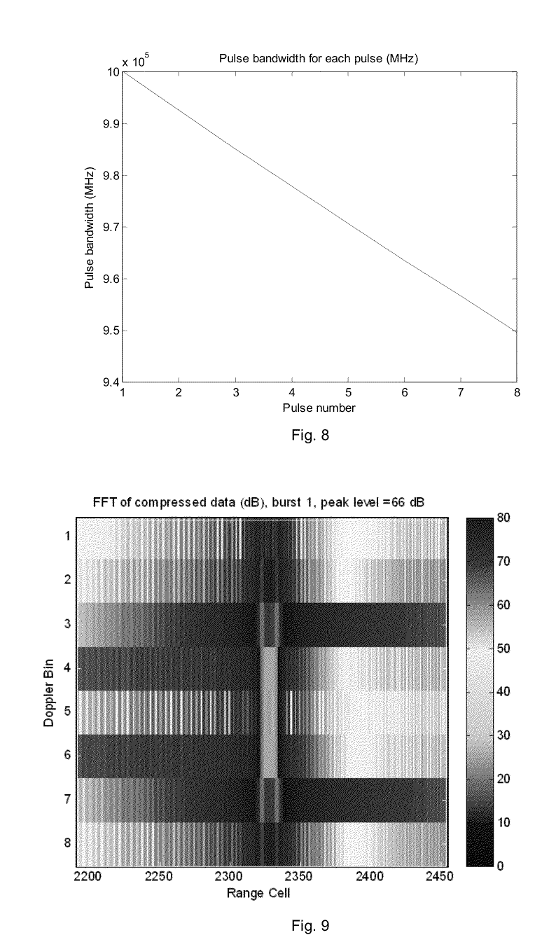

FIG. 8 illustrates how bandwidth of a linear chirp may be varied from pulse to pulse in accordance with another embodiment of the invention;

FIG. 9 illustrates the power spectrum of the pulse compressed returns from a modelled coherent burst of 8 pulses of a conventional radar system;

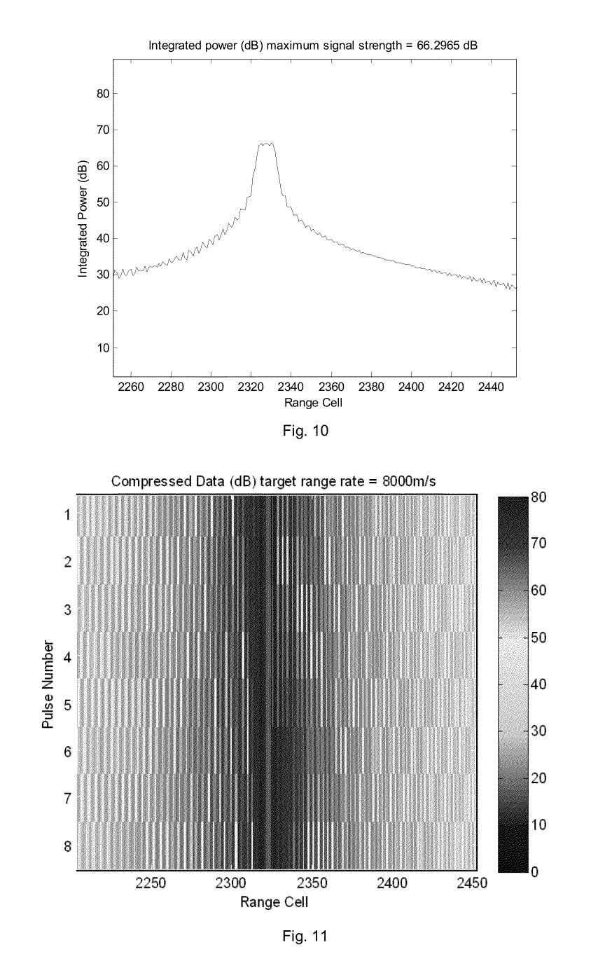

FIG. 10 illustrates the coherently integrated power of the pulse compressed returns from a modelled coherent burst of 8 pulses of a conventional radar system;

FIG. 11 illustrates the modelled power in each range cell of a pulse compressed radar system with a pulse-to-pulse bandwidth variation as shown in FIG. 8;

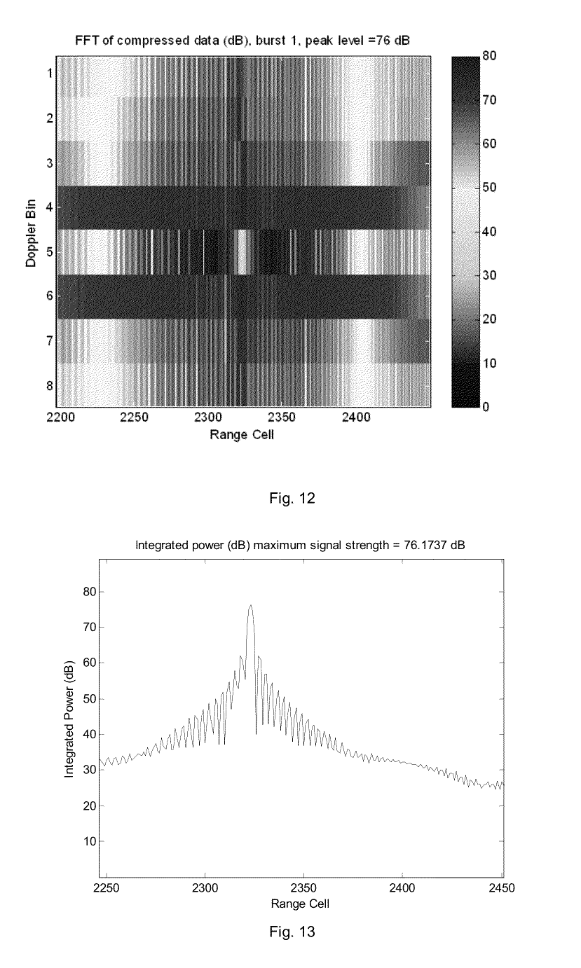

FIG. 12 illustrates the power spectrum of the pulse compressed returns illustrated in FIG. 11;

FIG. 13 illustrates the coherently integrated power of the signal returns shown in FIG. 11;

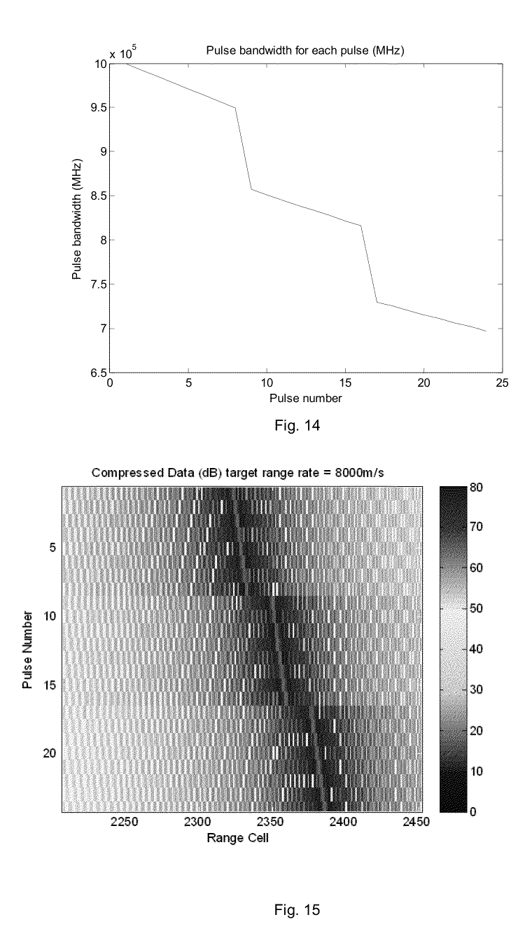

FIG. 14 how bandwidth of a linear chirp may be varied from pulse to pulse and from burst to burst in accordance with another embodiment of the invention;

FIG. 15 illustrates the modelled power in each range cell of a conventional pulse compressed radar system with three coherent bursts of eight pulses and a frequency variation between bursts;

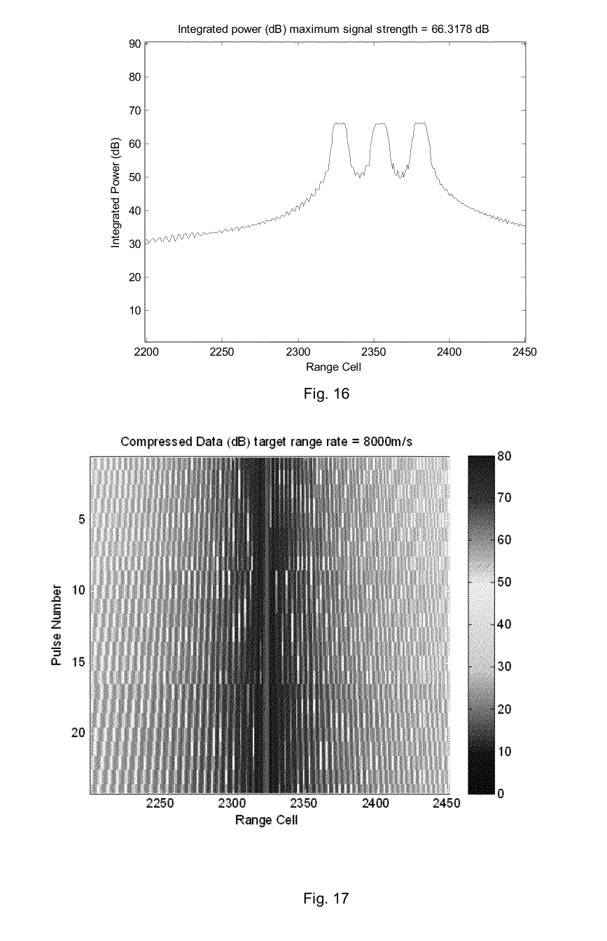

FIG. 16 illustrates the integrated power of the signal returns shown in FIG. 15;

FIG. 17 illustrates the modelled power in each range cell of a pulse compressed radar system with a pulse-to-pulse bandwidth variation as shown in FIG. 14; and

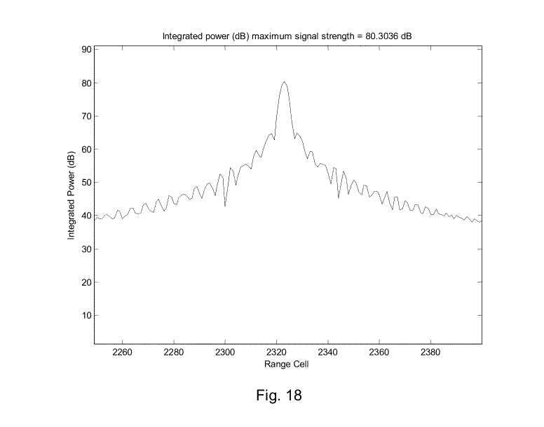

FIG. 18 illustrates the integrated power of the signal returns shown in FIG. 17.

FIG. 1 illustrates the basic operation of a pulse-compression radar. The radar system 101 comprises a pulse controller 102 which controls a transmitter module 103 to generate and transmit a series of pulses 104. The series of pulses is generated within the dwell time of a given look direction of the radar 101.

Each individual pulse in the series is modulated with a frequency modulation which typically may be a substantially linear chirp. A linear chirp, as one skilled in art will appreciate, is a frequency modulation where the rate of frequency change is substantially constant and thus results in a frequency that varies linearly with time such as illustrated in FIG. 2. FIG. 2 shows that the frequency of the pulse may increase from a first frequency, f1 to a second frequency f2 over the duration, τ, of the pulse. The total frequency change, f2−f1, is the bandwidth, B, of the chirp. It will be appreciated that FIG. 2 shows an ‘up-chirp’ where the frequency of the pulse increases over time but equally the chirp could be a ‘down-chirp’ of decreasing frequency.

It will also be understood by one skilled in the art that other frequency modulations than linear chirps may be applied to the pulses of pulse-compression radar, for instance for the purposes of controlling sidelobes etc.

Referring back to FIG. 1 return signals received by the radar system 101 may be passed to a pulse compression module 105 that applies known pulse compression techniques to produce a pulse compressed signal wherein, simplistically speaking, the various frequency components are combined so as to approximate the returns from a pulse with a duration less than duration, τ, of the transmitted pulse. Thus the range resolution of the radar system is governed by the compressed pulse duration, limited by the transmitted bandwidth, rather than the transmitted pulse duration directly.

The pulse compression module therefore produces, for each pulse, a series of pulse compressed samples in different range bins. Signal processor 106 then receives the pulse compressed samples and integrates the samples.

The integration may involve one or both of incoherent integration and coherent integration. Coherent integration combines the pulse-compressed samples taking phase and amplitude into account. Coherent integration requires however that the frequency of the pulses is the same from pulse to pulse.

It is noted at this point that, as mentioned above, the transmitted pulse has a frequency modulation and thus has a frequency which varies during the pulse duration. For coherent integration it is important that the nominal frequency of the pulse, for instance the centre frequency of the transmitted pulse, is the same from pulse to pulse as one skilled in the art will readily appreciate. FIG. 2 illustrates the centre frequency, f_{C}, of the pulse (which for a linear chirp is equal to (f2+f1)/2), which is the nominal frequency of the chirped pulse.

In a conventional radar system involving coherent integration the pulse generator 102 may therefore be arranged to generate a plurality of pulses having the same frequency as one another, the returns from which can be coherently integrated.

Incoherent integration combines the pulse compressed samples on the basis of detected amplitude only. This provides a reduced gain in signal-to-noise ratio (SNR) compared with coherent integration but may be relatively easier to implement and also can allow frequency agility of the radar system.

The signal returns from any target object will depend on a number of factors and may be frequency dependent. Thus pulses transmitted at one nominal frequency may result in relatively poor signal returns whereas pulses at a different nominal frequency may result in significantly better signal returns. Interference may also adversely effect target detection on certain frequencies. To increase detection probability many radar systems therefore use pulses having different nominal frequencies within the dwell time of a given look direction and incoherently integrate the returns from the different pulses.

In a conventional pulse-compression radar system the pulses transmitted in a given look direction may therefore be generated at a fixed pulse repetition interval (PRI) and each pulse may have the same general waveform, i.e. pulse duration and frequency modulation, but at least some pulse may be transmitted with a different nominal frequency to other pulses. Typically a burst of identical pulses at one nominal frequency may be transmitted, followed by at least one other burst of pulses at a different nominal frequency.

As mentioned previously applications such as detection of satellites in orbit or other fast moving distant objects typically require a relatively long dwell time to provide sufficient signal returns. In such applications the problem of range walk can reduce the SNR gains of integration. Thus if a target object 107 has a relatively high radial velocity, v, the target may move a distance greater than the division between range cells within the dwell time and may move a real distance equal to several range cells.

Also it will be appreciated that the radial velocity of the target will lead to a Doppler shift in the signal returns. The Doppler shift will vary depending on the frequency of the transmitted pulse, as will be well understood by one skilled in the art. Thus in a radar system which uses pulses of different frequency to provide frequency agility the amount of Doppler shift will vary between the returns from such pulses. Also, even within a single pulse it will be appreciated that the frequency modulation will lead to a change in the amount of Doppler shift over the lifetime of the pulse.

In a pulse compression radar system the pulse compression process means that the amount of Doppler shift in the received signal will affect the range bin in which the signal is detected. The link between the amount of Doppler shift observed in the returned signal and subsequent variation in range cell of the pulse compressed returns is known as range-Doppler coupling.

In conventional radar systems a variation in range Doppler coupling and/or real target movement between range cells within the dwell time of a look direction are seen as problems which reduce the integrated SNR of the radar system and/or require computational intensive receiver signal processing to address.

Embodiments of the present invention however deliberately use the effects of range-Doppler coupling to substantially compensate for the effects of real target motion.

Thus in one embodiment the pulse generator 102 of radar system 101 is configured to control generation of a series of pulses of electromagnetic radiation to be transmitted by the radar system, wherein the time between pulses and pulse characteristics are controlled such that any range migration due to target movement in the time between pulses of said series is substantially equal and opposite to any variation in range-Doppler coupling between the pulses due to said target movement. In this way the pulse compressed target position remains in the same range cell from pulse to pulse, independent of target radial velocity.

As in conventional pulse compression radar systems each pulse has a time-varying frequency modulation, which may be, for example a substantially linear frequency chirp such as shown in FIG. 2.

For a quasi-linear chirp, the range-Doppler coupling in the pulse compressor is given by

$${RangeDopplerCoupling}_{p} = \frac{{f}_{{D}_{p}}}{{ChirpRate}_{p}} * \frac{C}{2} \qquad Eqn . 1$$

where the target Doppler frequency is given approximately by

$${f}_{{D}_{p}} = 2 \frac{v}{{λ}_{p}} \qquad Eqn . 2$$

where v is the target radial velocity, λₚ is the nominal wavelength of the pth pulse, C is the speed of light and the chirp rate is the rate of change of frequency at the centre of the waveform.

For a linear chirp the chirp rate is given by:

$$ChirpRate = + \text{/} - \frac{{B}_{p}}{{τ}_{p}} \qquad Eqn . 3$$

where the sign is dependent on whether the pulse has an ‘up’ or ‘down’ chirp and Bₚ is the bandwidth of the chirp τₚ and is the duration of the transmitted pth pulse.

The range walk during the time interval from the first pulse to the pth pulse is given by

RangeMigrationₚ=v(tₚ−t₁) Eqn. 4

In order for the target range cell to be the same for all pulses then range walk together with the range-Doppler coupling should be constant, i.e.:

RangeMigrationₚ+RangeDopplerCouplingₚ=const Eqn. 5

Using equations 1-4 this gives:

$$v ( {t}_{p} - {t}_{1} ) + \text{/} - v \frac{{τ}_{p} C}{{λ}_{p} {B}_{p}} = v ( {t}_{p - 1} - {t}_{1} ) + \text{/} - v \frac{{τ}_{p - 1} C}{{λ}_{p - 1} {B}_{p - 1}} \qquad Eqn . 6$$

Rearranging, it can been seen that this requires the time between two pulses, tₚ-tₚ₋₁, to be equal to:

$${t}_{p} - {t}_{p - 1} = \frac{{τ}_{p} {F}_{p}}{{B}_{p}} - \frac{{τ}_{p - 1} {F}_{p - 1}}{{B}_{p - 1}} \qquad Eqn . 7$$

where Fₚ is the nominal frequency of the pth pulse.

The pulse generator 102 is thus arranged to generate a series of pulses such that time between pulses and the pulse characteristics, i.e. pulse duration, nominal frequency and frequency modulation (e.g. bandwidth of a linear chirp), substantially satisfy equation 7. In this way, for any target motion between pulses any range walk between range cells due to real target motion will be offset by range-Doppler coupling.

In some applications the pulse generator 102 may maintain a constant time difference between successive pulses, i.e. a constant pulse repetition interval, PRI, for at least some of the pulses. For a constant PRI, equation 7 reduces to:

$$PRI = \frac{{τ}_{p} {F}_{p}}{{B}_{p}} - \frac{{τ}_{p - 1} {F}_{p - 1}}{{B}_{p - 1}} \qquad Eqn . 8$$

If, in addition, the waveforms are the same for all pulses, i.e. all pulses have the same duration and chirp bandwidth then:

$$PRI = \frac{τ}{B} ( {F}_{p} - {F}_{p - 1} ) \qquad Eqn . 9$$

In other words the pulse generator may be arranged to vary the nominal frequency of pulses between at least some of the pulses according to equation 9. This will ensure that, using a constant pulse repetition interval and the same form of chirp applied to each pulse the range-Doppler coupling variation between pulses is offset by the actual range walk due to target motion. Such a variation in frequency will also inherently provide frequency agility to the radar system.

As noted previously however coherent integration of pulses relies on the nominal pulse frequency remaining constant from pulse to pulse. In some embodiments therefore the pulse generator 102 may be arranged to generate at least one coherent burst of pulses. The burst may also use a constant PRI is also used and thus the pulse generator may vary at least one of the pulse duration and/or chirp bandwidth according to:

$$\frac{PRI}{F} = \frac{{τ}_{p}}{{B}_{p}} - \frac{{τ}_{p - 1}}{{B}_{p - 1}} \qquad Eqn . 10$$

Thus the pulse generator can produce one or more coherent bursts of pulses by varying the bandwidth of the chirp applied to each pulse according to equation 10 above. The returns received from such a coherent burst and output from pulse compression module 105 can then be coherently integrated directly by signal processor 106 without requiring any additional detection side signal processing.

Additionally or alternatively one or more pulses having different frequencies according to equation 9 may be transmitted and the signal returns output from pulse compression module 105 incoherently integrated without any need for any other signal processing.

It will be appreciated by one skilled in the art that varying the nominal frequency of transmitted pulses is well within the ability of many existing radar systems and thus the methods of the present invention may be applied to many existing radar systems requiring only suitable adjustment of the pulse generation module. Likewise some existing radar systems may be readily able to adjust at least one of pulse duration and/or chirp bandwidth.

In many modern radar systems the generation of the chirp waveforms may typically be performed using a direct digital synthesiser (DDS), which generates a baseband signal output which is then frequency up converted, using a mixer, to the radio frequency (nominal or carrier frequency) for transmission. On the receive side the radio frequency returns are down converted using a mixer to baseband. The baseband returns may then be digitised and pulse compression is performed in a suitable computer/processor.

It can therefore be seen that the transmitted waveforms can readily be arbitrarily changed and the appropriate matched pulse compression filters can be generated, all under software control. Thus embodiments of the present invention can be applied to many existing radar systems by appropriate modification of the control software.

The examples described above have used a fixed pulse repetition interval but it will be appreciated that this is not necessary and in some instances it may be preferred to vary the pulse interval in addition to or instead of some pulse characteristic such as a chirp bandwidth.

It will also be understood that whilst the description has focussed on a substantially linear chirp, as this is the most commonly used frequency modulation, other frequency modulations could be used if desired.

In order to demonstrate the advantages of the embodiments of the present invention the following examples were modelled assuming linear chirps on transmit pulses of unity amplitude, with pulse compression weights based on the conjugate of the transmitted waveforms with a Kaiser weighted window, to reduce range sidelobes. For simplicity no receiver noise was modelled.

### EXAMPLE 1

The first example models the technique being applied to pulses having the same waveform, i.e. pulse duration and chirp bandwidth, generated at a constant pulse repetition interval. This shows how embodiments of the present invention could be utilised with a simple radar with limited range of pulse waveforms.

The modelled radar system had the following parameters. Within a given dwell time eight pulses are transmitted and the signal returns incoherently integrated. The pulse repetition interval, PRI, is constant and equal to 0.01 s. The returns are samples at a rate of 2.5 Mhz and each pulse has a duration, τ, equal to 400 μs. A linear chirp is applied to each pulse with a bandwidth, B, of 1 MHz. The (nominal) frequency of the first pulse in the series is 3 GHz. The target radial velocity is modelled as −8000 ms⁻¹.

The performance of a conventional radar system was modelled, in which case the frequency of each pulse was the same (but the returns were incoherently combined). The performance of a radar system according to an embodiment of the invention was also modelled, in which case the frequency is varied from pulse to pulse according to the following equation and the result incoherently combined:

$${F}_{p} - {F}_{p - 1} = PRI \frac{B}{τ} \qquad Eqn . 11$$

FIG. 3 illustrates the frequency variation between the pulses across the dwell calculated according to equation 11 above.

FIG. 4 shows the modelled pulse compressed returns from the conventional radar system with a fixed frequency of 3 GHz for all of the eight pulses. FIG. 4 illustrates the energy received in a selection range cells for each pulse, i.e. the pulse compressed output for each pulse. The range migration during the dwell is clearly visible. FIG. 5 shows the resulting integrated signal from all of the pulses. The peak power is about 61.7 dB and it can be seen that there is a relatively broad spread of power between several range cells.

FIG. 6 however shows the modelled pulse compressed returns for pulses using the frequency variation of equation 11. It can be seen that the pulse compressed target data is now aligned from pulse to pulse. FIG. 7 shows the integrated signal power for the data using the technique of the present invention. The peak signal level using the frequency variation described is now about 67.3 dB. This represents a peak signal level of about 5.6 dB higher than achieved without using the method of the present invention. It can also be seen that the peak is much narrower with most of the energy concentrated in fewer range cells.

Note that by using a mixture of up and down chirps, or by using different pulse lengths and/or bandwidths, the predictable monotonic variation of frequency over the dwell can be avoided, which would be beneficial to avoid jamming.

### EXAMPLE 2

A second example was modelled to show the techniques of the present invention applied to a coherent burst of pulses.

In this example the same model parameters were used for the conventional radar system but this time the returns from the eight pulses were coherently combined.

For the radar system according to the present invention each pulse was modelled as having a nominal frequency of 3 GHz that was kept the same from pulse to pulse. However the chirp bandwidth was changed from pulse to pulse, from a starting bandwidth of 1 MHz, according to the following equation;

$${B}_{p} = {( \frac{PRI}{{F}_{burst}} \pm \frac{τ}{{B}_{p - 1}} )}^{- 1} \qquad Eqn . 12$$

FIG. 8 shows the calculated pulse bandwidth for each pulse in the dwell according to equation 12.

As with the first example the pulse compressed signal returns from the modelled conventional radar system without any bandwidth variation exhibits range walk between the pulses (such as shown in FIG. 4). FIG. 9 shows the power spectrum of the compressed returns from the modelled conventional radar system obtained by applying an fast Fourier transform (FFT) to the data. It can be seen that the returns exhibit a spread in both range and in Doppler around the target position. It will be appreciated that this spread in Doppler is due to the migration of the target through range cells during the dwell which gives rise to a time varying amplitude in any range cell FIG. 10 shows the coherently integrated power for the eight pulses and it can be seen that with coherent integration the peak power is around 66.2 dB. This is an improvement on the peak achieved by the conventional radar system in example 1, i.e. using only incoherent integration but still isn't as good as the power achieved by using the techniques of the present invention described in example 1.

FIG. 11 shows the pulse compressed returns achieved using the bandwidth variation according to equation 12. Again it can be seen that the target returns are all range aligned. FIG. 12 shows the corresponding power spectrum of the compressed returns which are localised in range and Doppler. FIG. 13 show the integrated signal levels using the technique of the present invention. The peak signal level is around 76.2 dB, which is about 9.9 dB higher than achieved without using the technique of the present invention.

### EXAMPLE 3

To illustrate how both coherent and incoherent integration techniques can be used with the present invention a radar system was modelled having three coherent bursts of pulses at different frequencies, with a constant frequency within the burst. The returns from the pulses within a burst were coherently combined with the result of the three separate bursts being incoherently combined.

The modelled parameters were three bursts of eight pulses per burst. The pulses within each burst were at 2.7, 3.0 and 3.3 GHz respectively. The PRI was constant between the pulses at 0.01 s and the pulse duration was 400 μs. The sampling rate was again 2.5 MHz and the modelled target velocity was −8000 ms⁻¹.

For the modelled conventional radar system the bandwidth of the linear chirp applied to each pulse was 1 MHz. For the radar system according to an embodiment of the present invention the bandwidth of the first pulse was 1 MHz and then the bandwidth of the pulses was varied according to equation 12 above.

FIG. 14 illustrates how the bandwidth varies with pulse throughout the 24 transmitted pulses. It can be seen that, in addition to a bandwidth change from pulse to pulse there is a relatively large change in bandwidth from burst to burst as the pulse frequency changes. It will be appreciated that in some embodiments it may not be desirable to have such a significant change in chirp bandwidth as thus in some embodiments it may be additionally or alternatively desirable to change the pulse interval.

FIG. 15 shows the pulse compressed returns from the modelled conventional radar system. It can be seen that there is range walk in the pulse compressed returns within a burst and a large step in target compressed range between bursts. FIG. 16 shows the resultant integrated signal level. It can be seen that there are three distinct peaks, corresponding to the three bursts and the peak signal power is about 66.3 dB.

By contrast FIG. 17 shows the compensated target returns for the embodiment according to the present invention. It can be seen that all of the target returns are all aligned in range, both within a burst and between bursts. FIG. 18 shows the integrated signal levels using the technique of the present invention. There is a single peak of the order of 80.3 dB. This is about 13.9 dB larger than the modelled conventional system.

It can therefore be seen that the techniques of the present invention can provide significant advantages in increased detected signal power and reduced target range ambiguity. Further it will be clear that these advantages can be provided purely by adjusting the pulse characteristic of the transmitted pulses without requiring any additional detector side signal processing. The relevant pulse waveforms may be achievable by some existing radar systems and in other systems the advantages of the present invention may be realised by retrofitting suitable pulse generators to the radar systems.

Embodiments of the present invention have been described, principally with respect to radar systems. As mentioned previously the techniques may also be applicable to other pulsed detection systems which may use pulse compression techniques, such as lidar or sonar. The techniques could also be advantageously applied to such other systems if the system configuration is such that significant range walk could occur within a dwell time.

1. A pulse controller for a pulsed target detection system, the pulse controller being configured to, in use, control generation of a series of pulses to be transmitted by the pulsed target detection system, wherein the time between pulses and pulse characteristics are controlled such that any range migration due to target movement in the time between pulses of said series is substantially equal and opposite to any variation in range-Doppler coupling between the pulses due to said target movement.

2. The pulse controller as claimed in claim 1, wherein each pulse has a time-varying frequency modulation.

3. The pulse controller as claimed in claim 2, wherein said pulse characteristics controlled comprise at least one of nominal pulse frequency, pulse duration and applied frequency modulation.

4. The pulse controller as claimed in claim 2, wherein said time-varying frequency modulation comprises a substantially linear frequency chirp.

5. The pulse controller as claimed in claim 4, wherein the pulse controller is configured to generate pulses that substantially satisfy the equation:
$${t}_{p} - {t}_{p - 1} = \frac{{τ}_{p} {F}_{p}}{{B}_{p}} - \frac{{τ}_{p - 1} {F}_{p - 1}}{{B}_{p - 1}}$$
wherein t is the time of pulse transmission, τ is the pulse duration, F is the nominal pulse frequency and B is the bandwidth of the frequency chirp and the subscript p-1 denotes a first pulse and the subscript p denotes a later pulse in the series.

6. The pulse controller as claimed in claim 1, wherein the controller is configured to, in use, generate a plurality of pulses at a constant pulse repletion interval.

7. The pulse controller as claimed in claim 1, wherein the controller is configured to, in use, vary the nominal frequency of at least some pulses in the series.

8. The pulse controller as claimed in claim 1, wherein the controller is configured to, in use, generate at least some pulses having the same nominal frequency.

9. A radar system, comprising;
the pulse controller as claimed in claim 1.

10. The radar system as claimed in claim 9, further comprising a detector configured to produce pulse compressed signal returns from each of said pulses and integrate at least some of pulse compressed signal returns.

11. A method of target detection, comprising;
transmitting a series of pulses in a given look direction, wherein the time between pulses and pulse characteristics are configured such that any range migration due to target movement in the time between pulses of said series is substantially equal and opposite to any variation in range-Doppler coupling between the pulses due to said target movement.

12. The method as claimed in claim 11, wherein each pulse has a time-varying frequency modulation.

13. The method as claimed in claim 12, wherein said time-varying frequency modulation comprises a substantially linear frequency chirp.

14. The method as claimed in claim 13, wherein the time between pulses and pulse characteristics are configured so as to substantially satisfy the equation:
$${t}_{p} - {t}_{p - 1} = \frac{{τ}_{p} {F}_{p}}{{B}_{p}} - \frac{{τ}_{p - 1} {F}_{p - 1}}{{B}_{p - 1}}$$
wherein t is the time of pulse transmission, τ is the pulse duration, F is the nominal pulse frequency and B is the bandwidth of the frequency chirp and the subscript p-1 denotes a first pulse and the subscript p denotes a later pulse in the series.

15. A computer program that includes computer readable code for instructing a suitable processor to perform the steps of the method of claim 11.

16. A computer program that includes computer readable code which, when executed by a suitable computing device, enables the pulse controller as claimed in claim 1 to perform the following:
control generation of a series of pulses to be transmitted by the pulsed target detection system, wherein the time between pulses and pulse characteristics are controlled such that any range migration due to target movement in the time between pulses of said series is substantially equal and opposite to any variation in range-Doppler coupling between the pulses due to said target movement.
